(19) United States
(12) Patent Application Publication
(10) Pub. No.: US 2006/0284988 A1
(43) Pub. Date: Dec. 21, 2006

(54) IMAGE SIGNAL PROCESSOR AND IMAGING UNIT

(75) Inventor: Yoshio WAKUI, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/425,181

(22) Filed: Jun. 20, 2006

(30) Foreign Application Priority Data
Jun. 20, 2005 (JP) P2005-179257

(51) Int. Cl. H04N 5/225

(52) U.S. Cl. 348/222.1; 348/207.99

(57) ABSTRACT

An image signal processor comprising a first setting block and an adjustment block is provided. The setting block sets an exposure time. An optical image of an object is captured by an imaging device in order to generate an image signal during the exposure time. The adjustment block adjusts a black level of the image signal using a black signal if the exposure time is over a threshold time. The black signal is generated based on a signal output from a black pixel. The light receiving surface of the imaging device is shielded at the black pixel. The adjustment block adjusts a black level of the image signal using a dummy signal if the exposure time is under a threshold time. The dummy signal corresponds to the image signal when the exposure time is nearly zero.

### BACKGROUND OF THE INVENTION

1. Field of the Invention

The present invention relates to an image signal processor that adjusts a black level of an image signal generated by an imaging device, and an imaging unit that outputs an image signal with an adjusted black level.

2. Description of the Related Art

It is known that the black level is adjusted for an image signal generated by an imaging device, such as a CCD or a CMOS image sensor, for the purpose of displaying an accurate picture. Generally, the adjustment of the black level is carried out by subtracting a pixel signal corresponding to black color from a pixel signal forming the imaging signal.

Some methods of generation of a pixel signal corresponding to black color are known. For example, it is possible to cause a shielded photodiode to generate a pixel signal corresponding to black. However, the difficulty of completely shielding a photodiode results in that light may be leaked to the photodiode. Further it is proposed electrically to generate a pixel signal corresponding to black as a dummy signal. For example, a pixel signal, generated at a capacitor of a CCD in a situation where no signal charge is transmitted from a photodiode of a CCD, can be output as a dummy signal. However, it is impossible adequately to adjust the black level using the dummy signal when noise generated at a photodiode is large. This is because the dummy signal does not have a noise component generated at a photodiode, such as dark current.

### SUMMARY OF THE INVENTION

Therefore, an object of the present invention is to provide an image signal processing unit that adequately adjusts the black level of an image signal.

According to the present invention, an image signal processor comprising a setting block and an adjust block is provided. The setting block sets an exposure time. An optical image of an object is captured by an imaging device in order to generate an image signal during the exposure time. The adjustment block adjusts a black level of the image signal using a black signal if the exposure time is over a threshold time. The black signal is generated based on a signal output from a black pixel. The light receiving surface of the imaging device is shielded at the black pixel. The adjustment block adjusts a black level of the image signal using a dummy signal if the exposure time is under a threshold time. The dummy signal corresponds to the image signal when the exposure time is nearly zero.

### BRIEF DESCRIPTION OF THE DRAWINGS

The objects and advantages of the present invention will be better understood from the following description, with reference to the accompanying drawings in which:

FIG. 1 is a block diagram showing the internal structure of a digital camera having an image signal processor of an embodiment of the present invention;

FIG. 2 is a block diagram showing the structure of the CCD imaging device;

FIG. 3 is a correlation diagram between the ISO sensitivity and the threshold time;

FIG. 4 is a flowchart describing the generation of the pixel signal and the predetermined signal processes;

FIG. 5 is a circuit diagram showing the structure of the CMOS imaging device that can generate the image-pixel signal, a black signal, and a dummy signal;

FIG. 6 is a circuit diagram showing the structure of the image pixel; and

FIG. 7 is a circuit diagram showing the structure of the dummy pixel.

### DESCRIPTION OF THE PREFERRED EMBODIMENTS

The present invention is described below with reference to the embodiment shown in the drawings.

A digital camera 10 comprises a photographic optical system 11, an imaging device 30, such as a CCD, a digital signal processor 12, a system controller 13, a monitor 14, and other compounds.

The photographic optical system 11 is optically connected to the imaging device 30. An optical image of an object (not depicted) passes through the photographic optical system 11, and reaches a light receiving surface of the imaging device 30. Then, the imaging device 30 captures the optical image, and generates an image signal corresponding to the optical image.

The imaging device 30 is electrically connected to the digital signal processor 12 through an A/D converter 15. The image signal, which is an analog signal, is converted to a digital signal by the A/D converter 15. The image signal is sent to the digital signal processor 12 after A/D conversion. The image signal, input to the digital signal processor 12, is stored in a DRAM 16 for signal processing. The digital signal processor 12 carries out some predetermined signal processes, including a black balance process explained in detail later, for the image signals stored in the DRAM 16.

The digital signal processor 12 is electrically connected to a monitor 14 through a system controller 13. The image signals, having undergone the signal processing in the digital signal processor 12, are sent to the monitor 14. The image corresponding to the image signals, is displayed on the monitor 14.

The system controller 13 is connected also to a memory connector 18. A memory card (not depicted) can be connected to and disconnected from the memory connector 18 as required. The image signals, having undergone the signal processing, can be sent to and stored by the memory card.

The system controller 13 is electrically connected to an input unit 19, comprising a release switch (not depicted), a power switch (not depicted), a mode-change switch (not depicted), a shutter speed dial (not depicted), an ISO sensitivity dial (not depicted), and other input devices. The system controller 13 carries out operations of the digital camera 10 based on the user's input to the input unit 19.

When an auto exposure mode is selected based on an input to the mode-change switch, the system controller 13 controls operations of a shutter (not depicted) and a diaphragm (not depicted). To control the operations, at first, an exposure time and an aperture ratio of the diaphragm is calculated based on an amount of light intensity measured by a photometry sensor 20. Next, an electronic shutter or a mechanical shutter is driven based on the calculated exposure time, and the diaphragm is driven based on the calculated aperture ratio.

In addition, it is possible manually to adjust the exposure time based on an input to the shutter speed dial. The electronic shutter or the mechanical shutter is driven by the system controller 13 based on an input to the shutter speed dial.

The system controller 13 controls all the operations of the digital camera 10. For example, the system controller 13 controls an imaging device driver 21 to drive the imaging device 30. The system controller 13 is connected with the ROM 17, storing necessary data for the system controller 13 to control the operations of the digital camera 10.

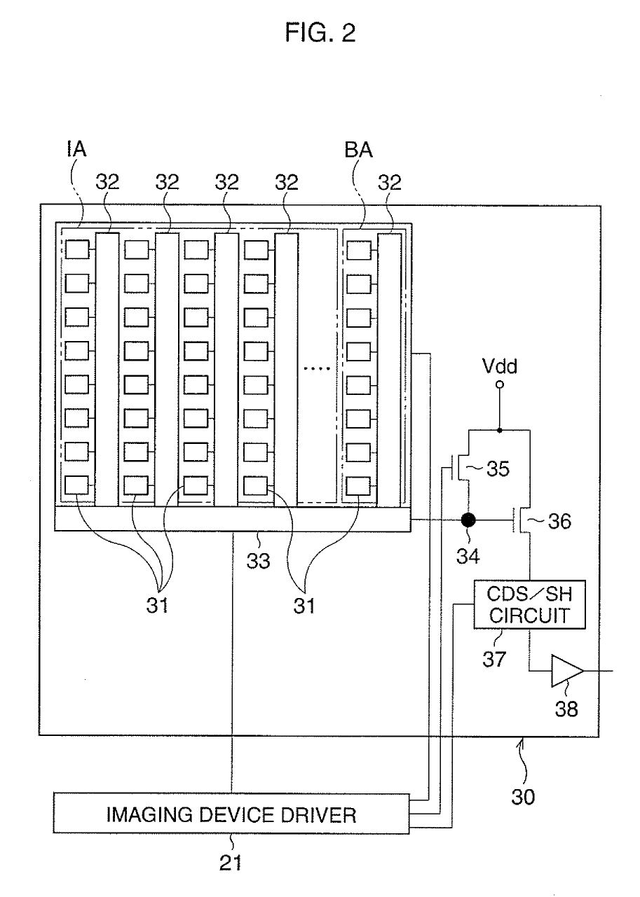

Next, the structure of the imaging device 30 and a signal output from the imaging device 30 are explained using a block diagram of FIG. 2.

The imaging device 30 comprises pixels 31, a vertical CCD 32, a horizontal CCD 33, a floating diffusion (FD) 34, a reset transistor 35, an amplifier transistor 36, a correlated double sampling/sample and hold (CDS/SH) circuit 37, and an output block 38. The pixels 31 comprise a photodiode (PD) carrying out an opto-electric conversion in this embodiment.

There is an imaging area, hereinafter referred to as IA, and a black area, hereinafter referred to as BA, at a light receiving surface of the imaging device 30. Some pixels 31 are arranged in a matrix in the IA and the BA. The pixels 31, arranged in the IA, generate a signal charge according to the amount of light received at the pixels 31, and then the signal charge is stored by the pixels 31. The pixels 31, arranged in the BA, are shielded. The pixels 31, arranged in the BA, generate a signal charge according to noise, such as dark current, and then the signal charge is stored by the pixels 31.

A plurality of the pixels 31 lined vertically are connected with the vertical CCD 32. One end of the vertical CCD 32 is connected to the horizontal CCD 33. The output terminal of the horizontal CCD 33 is connected to the FD 34.

A signal charge generated by each pixel 31 is transmitted to the FD 34 by the vertical CCD 32 and the horizontal CCD 33. A signal pulse for vertical transmission, which causes the vertical CCD 32 to transmit the signal charge, is input to the vertical CCD 32 from the imaging device driver 21. A signal pulse for horizontal transmission, which causes the horizontal CCD 32 to transmit the signal charge, is input to the horizontal CCD 32 from the imaging device driver 21,

The FD 34 is a capacitor. The FD 34 stores the transmitted signal charge. The electrical potential of the FD 34 changes according to the stored signal charge. The FD 34 is connected to the reset transistor 35.

The reset transistor 35 sweeps a signal charge, stored by the FD 34, to a power source, hereinafter referred to as Vdd, when the reset transistor 35 receives a reset signal. The FD 34 is reset by sweeping the signal charge, and then the electrical potential of the FD 34 is reset to the electrical potential that is left by the threshold potential of the reset transistor 35 subtracted from the potential of the Vdd.

The FD 34 is connected to a gate of the amplifier transistor 36. The source of the amplifier transistor 36 is connected to the output block 38 through the CDS/SH circuit 37. An electrical potential signal in accordance with the electrical potential of the FD 34 is output as a pixel signal from the source of the amplifier transistor 36. Consequently, generation of the pixel signal based on the signal charge is carried out by the FD 34 and the amplifier transistor 36 together as one unit (first signal generator).

The CDS/SH circuit 37 carries out a correlated double sampling for the pixel signal. By the correlated double sampling, a potential difference between an electrical potential signal of the reset FD 34 and an electrical potential signal of the FD 34 storing a signal charge is sampled and held as a pixel signal. The pixel signal is output from the imaging device 30 through the output block 38.

Some pixel signals, generated based on a signal charge of some pixels 31 arranged in the IA, are output as an image-pixel signal generated by capturing the optical image of the object. Some pixel signals, generated based on a signal charge of some pixels 31 arranged in the BA, are output as a black signal for adjustment of a black level of the image signal.

The signal pulse for horizontal transmission causes the horizontal CCD 33 to form a number of electrical wells, and causes the electrical wells to move along the horizontal CCD 33. The electrical wells can receive and store a signal charge transmitted from the vertical CCD 32. A signal charge is transmitted by moving an electrical well storing a signal charge. The electrical wells are moved faster in proportion to a higher frequency of the signal pulse for horizontal transmission. A frequency to form the same electrical wells as the pixel signals generated by the pixels 31 arranged in one row is defined as a horizontal-transmission frequency. An empty electrical well, which does not receive a signal charge from the vertical CCD 32, can be formed by setting the frequency of the signal pulse for horizontal transmission higher than the horizontal-transmission frequency. A charge corresponding to noise may be generated in all electrical wells during the transmission through a horizontal CCD. Such a charge is transmitted to the FD 34 by the empty electrical well, and then a pixel signal is generated as a dummy signal based on the charge by the FD 34 and the amplifier transistor 36.

The reset signal, which causes the reset transistor 35 to reset the FD 34, and an SH signal, which causes the CDS/SH circuit 37 to carry out a correlated double sampling, sampling and holding, are output from the imaging device driver at predetermined timings.

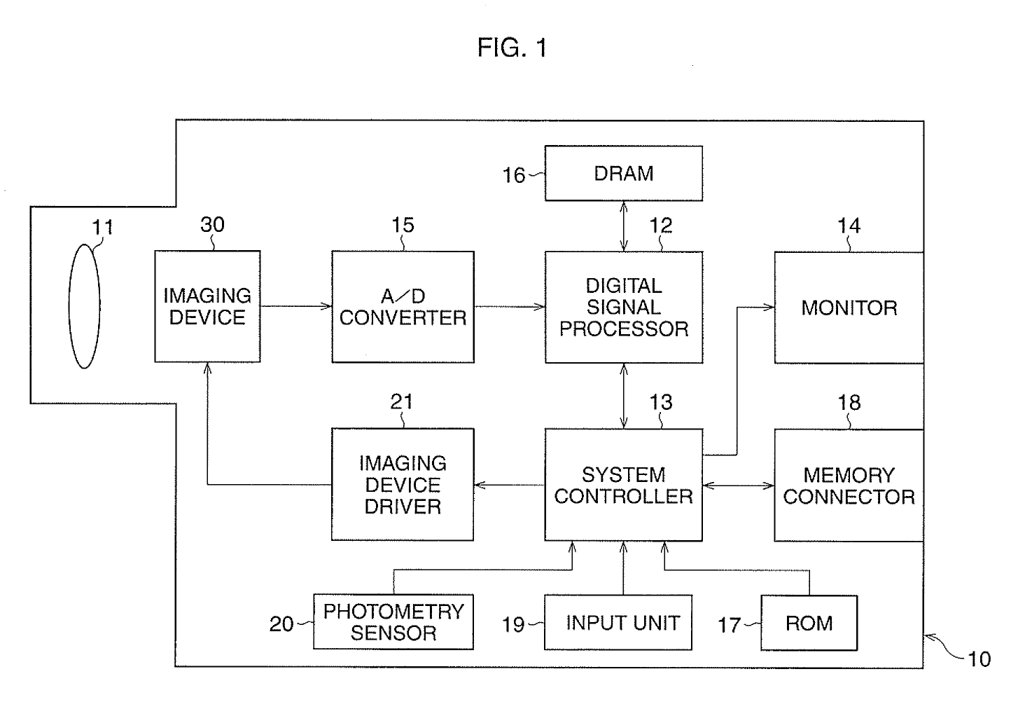

Next, the black balance process to adjust the black level of an image signal is explained. The image-pixel signal, the black signal, and the dummy signal, output from the imaging device 30, are converted from an analog signal to a digital signal by the A/D converter 15, and input to the digital signal processor 12 (see FIG. 1).

The digital signal processor 12 subtracts the black signal or the dummy signal from the image-pixel signal, and then the black level of the image-pixel signal is adjusted. The digital signal processor 12 carries out the black balance using either the black signal or the dummy signal.

The system controller 12 switches between the black signal and the dummy signal for the adjustment of the black level based on the exposure time (during which time the imaging device 30 captures an optical image of the object) and a threshold time.

The exposure time is calculated or manually adjusted, as described before, and set for driving the shutter, and for adjusting the black level by the system controller 12.

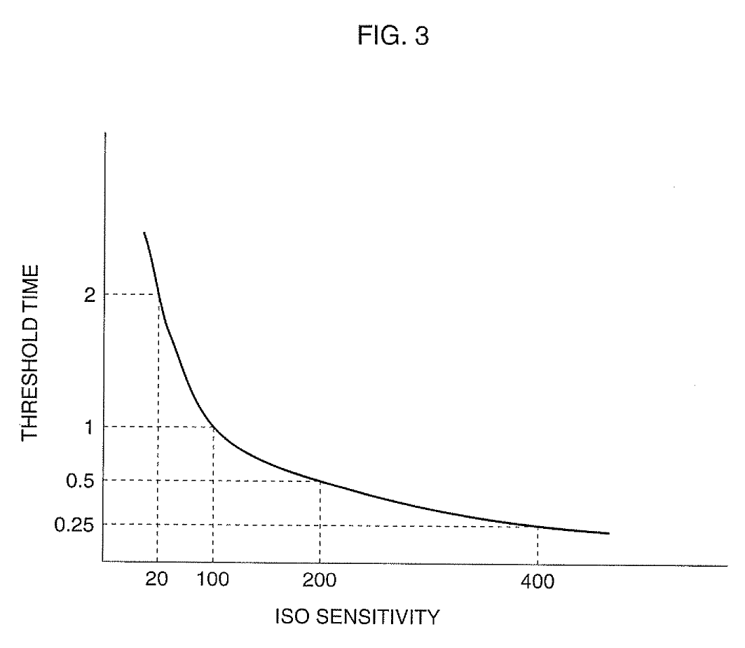

The threshold time is stored in the ROM 17 (see FIG. 1). The system controller 12 reads the threshold time as required. Some threshold times are predetermined according to some values of ISO sensitivity. The threshold time is predetermined to be short if the ISO sensitivity is high. On the other hand, the threshold time is predetermined to be high if the ISO sensitivity is low. For example, the threshold time is predetermined so that the threshold time and the ISO sensitivity are in inverse proportion, as shown in FIG. 3. When the ISO sensitivity is raised to be 50, 100, 200, or 400, the threshold time is setup to be 2, 1, 0.5, or 0.25 respectively. As described above, data for the threshold times are stored in the ROM 17 (see FIG. 1). When a user operates the ISO sensitivity dial so as to set up the ISO sensitivity, the system controller 13 selects and reads the threshold time according to the set ISO sensitivity.

The system controller 13 switches between the black signal and the dummy signal, as described before. The system controller 13 switches to the black signal when the exposure time is longer than the threshold time read by the system controller 13. In this case, a signal to cause the digital signal processor 12 to use the black signal is generated by the system controller 13 and sent to the digital signal processor 12. The system controller 13 switches to the dummy signal when the exposure time is shorter than the threshold time read by the system controller 13. In this case, a signal to cause the digital signal processor 12 to use the dummy signal is generated by the system controller 13 and sent to the digital signal processor 12.

The black level for all image-pixel signals, forming one frame, is adjusted based on either the black signal or the dummy signal. An amplification process is carried out for the image-pixel signal for which the black level is adjusted according to the ISO sensitivity, and then the other signal processes are carried out.

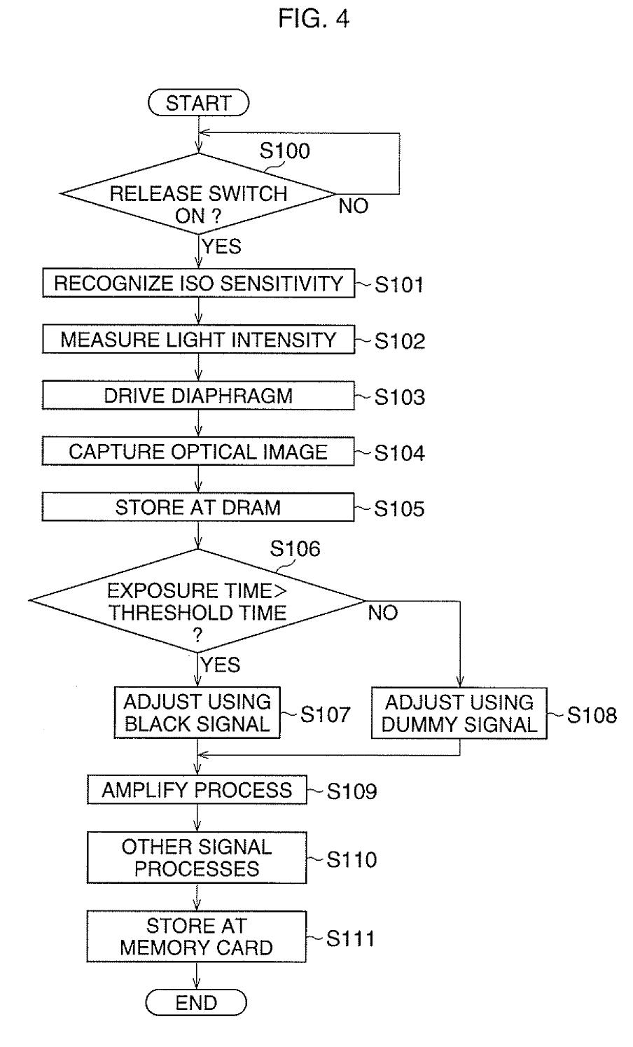

Next, the predetermined signal processes, including a black balance process, carried out by the system controller 13 and the digital signal processor 12, are explained using the flowchart of FIG. 4.

At step S100, it is determined whether the release switch is switched on. If the release switch is not switched on, step S100 is repeated until the release switch is switched on. If the release switch is switched on, the process goes to step S101.

At step S101, the ISO sensitivity, set up by the user's operating the ISO sensitivity dial, is read in. The threshold time according to the set ISO sensitivity is selected for the adjustment of the black level. A gain according to the set ISO sensitivity is selected for the amplification process.

At step S102, the photometry sensor 20 is activated to measure the light intensity of the object. Further, an exposure time and an aperture ratio for the diaphragm are calculated. And then the process goes to step S103. At step S103, the diaphragm is driven according to the aperture ratio for the diaphragm calculated at step S102.

At step S104, the imaging device 30 is activated to capture an optical image of an object. The electrical shutter or the mechanical shutter is driven so that the shutter speed corresponds to the exposure time calculated at step S102. Alternatively, the electrical shutter or the mechanical shutter is driven so that the shutter speed corresponds to the exposure time manually adjusted by operating the shutter speed dial if the exposure time is so manually adjusted.

At step S105, the image-pixel signal, the black signal, and the dummy signal, generated by the imaging signal 30, are stored in the DRAM 16. The process goes to step S106 after storing. At step S106, the threshold time selected at step S101 and the exposure time calculated at step S102 are compared.

If the exposure time is longer than the threshold time, the process goes to step S107. At step S107, the black signal is used for the adjustment of the black level for the image-pixel signal stored by the DRAM 16. A signal, generated by subtracting the black signal from the image-pixel signal in the adjustment, is stored as an image-pixel signal having undergone the black balance processing in the DRAM 16.

On the other hand, if the exposure time is shorter than the threshold time at step S106, the process goes to step S108. At step S108, the dummy signal is used for the adjustment of the black level for the image-pixel signal stored in the DRAM 16. A signal, generated by subtracting the dummy signal from the image-pixel signal in the adjustment, is stored as an image-pixel signal having undergone the black balance processing in the DRAM 16.

The process goes to step S109 after step S107 or step S108. At step S109, the amplification process is carried out for the image-pixel signal with the gain selected at step S101. At step S110, the other predetermined signal processes are carried out for the image-pixel signal, and the process goes to step S111. At step S111, the image-pixel signals are stored as an image signal by the memory card or the built-in memory. All processes finish after storing.

In the above embodiment, it is possible to adjust optimally the black level of the image signal. Consequently, the image quality of the displayed or stored image can be improved.

It is desirable to adjust the black level of the image signal using the black signal when a dark current is large enough to influence a signal charge generated by a pixel 31 in the IA. It is undesirable to adjust the black level using the black signal when leakage of light to a pixel 31 in the BA is significant. On the other hand, it is desirable to adjust the black level using the dummy signal when leakage of light to a pixel 31 in the BA is large enough to influence a signal charge generated by a pixel 31 in the BA. It is undesirable to adjust the black level using the dummy signal when a dark current is significant.

A dark current will be large in proportion to the length of the exposure time. In addition, the leakage of light to a pixel in the BA is too small to influence an adequate adjustment of the black level if the exposure time is long, for the reflected light intensity from the object is low when the exposure time is set up to be long. Accordingly, the black level of the image signal is optimally adjusted by using the black signal, including a dark current, when the exposure time is set up to be long.

The influence of the dark current is small when the exposure time is short. In addition, a dummy signal is not influenced by a leakage of light at all. So, the black level of the image signal is optimally adjusted by using the dummy signal when the exposure time is set up to be short.

In addition, the black level of the image signal is optimally adjusted by using a threshold time according to a set ISO sensitivity. The influence of a dark current is large when the ISO sensitivity is set up to be large. The dummy signal may be selected by using a fixed threshold time even if the influence of a dark current is significant. Either the black signal or the dummy signal can be adequately selected for an adjustment of the black level by using a threshold time set up to be short for a high ISO sensitivity or long for a low ISO sensitivity.

The threshold time can be changed according to a set up ISO sensitivity in the above embodiment. However, the threshold time may be changed according to any factors that change the influence of a dark current at the same exposure time. For example, if a gain to multiply an image signal is manually adjusted, the threshold time may be changed according to the gain manually adjusted. The influence of a dark current is large in proportion to the gain. Accordingly, the threshold time can be changed to be short as the adjusted gain is large, resulting in the same effect as in the above embodiment.

A digital signal processor 12 adjusts the black level of an image signal output from the CCD imaging device 30. However, the black level of an image signal output from any imaging devices can be adjusted by the digital signal processor 12 as long as the imaging device can output the image-pixel signal, the black signal, and a dummy signal equivalent to a pixel signal generated without a practical exposure time. For example, the black level of an image signal output from the CMOS imaging device explained below can be adjusted.

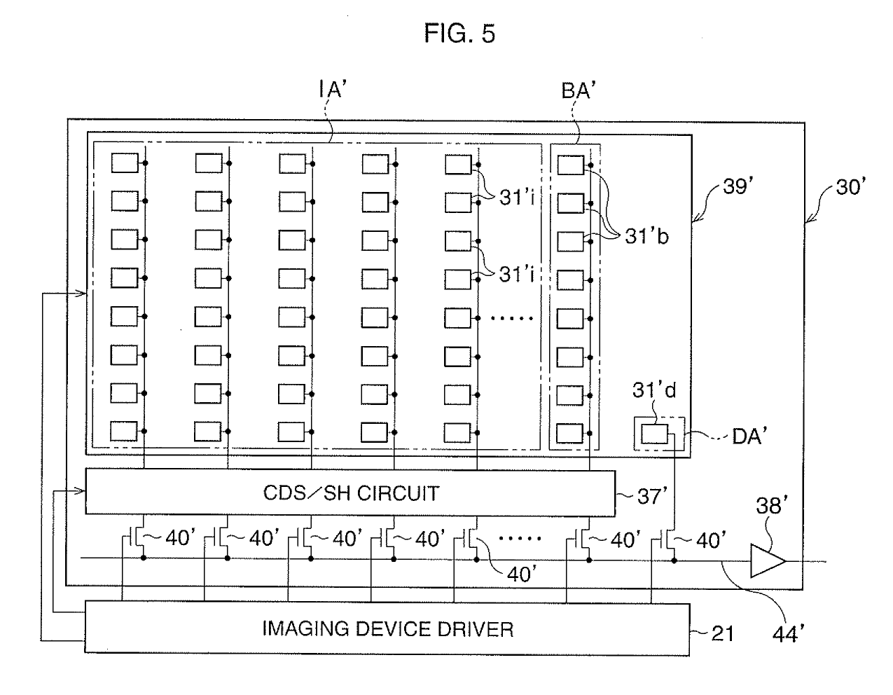

The structure of the CMOS imaging device is explained using the block diagram of FIG. 5. The CMOS imaging device 30′ comprises an imaging block 39′, a CDS/SH circuit 37′, column select transistors 40′, an output block 38′, and other compounds. The imaging block 39′ and the CDS/SH circuit 37′ generate and hold an image-pixel signal, a black signal, and a dummy signal in cooperation. The held image-pixel, black signal, and dummy signal are selected by the column select transistors 40′ to output through the output block 38′.

An imaging area, hereinafter referred to as IA′, a black area, hereinafter referred to as BA′, and a dummy area, referred to as DA′, are formed on a light receiving surface of the imaging block 39′. Some image pixels 31′i, some black pixels 31′b, and a dummy pixel 31′d are mounted in the IA′, the BA′, and the DA′ respectively.

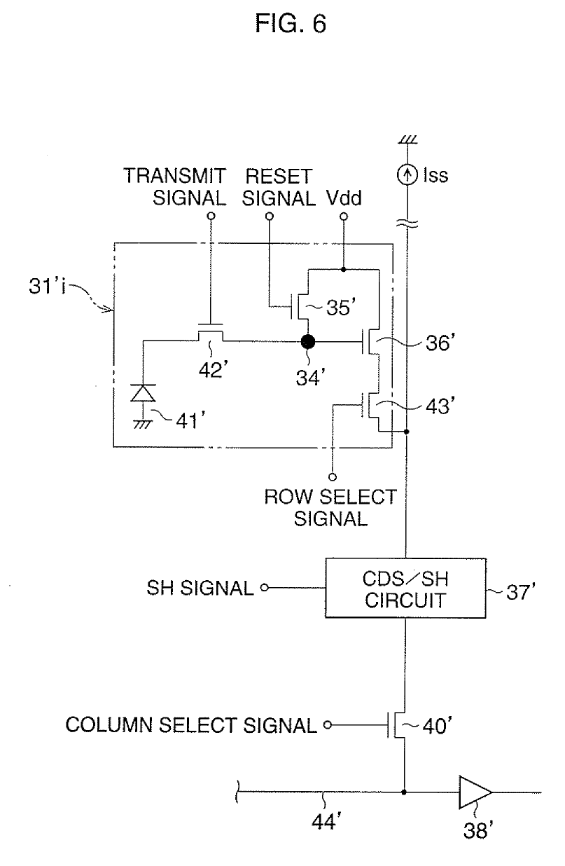

The structure of the image pixels 31′i is explained below using the circuit diagram of FIG. 6. The image pixel 31′i comprises a PD 41′, an FD 34′, a transmit transistor 42′, a reset transistor 35′, an amplifier transistor 36′ a row select transistor 43′, and other compounds.

A signal charge is generated at the PD 41′ according to the amount of light received. In addition, the PD 41′ stores the generated signal charge. The stored signal charge is transmitted to the FD 34′ by the transmit transistor 42′.

The FD 34′ is a capacitor that can receive and store the signal charge transmitted from the PD 41′. The electrical potential of the FD 34′ changes according to the stored signal charge. The FD 34′ is connected to the reset transistor 35′.

The reset transistor 35′ sweeps out the charge stored by the FD 34′ to a power source, hereinafter referred to as Vdd, when the reset transistor 35 receives a reset signal. The FD 34′ is reset by sweeping the signal charge, and then the electrical potential of the FD 34′ is reset to an electrical potential that accords with the potential of the Vdd.

The FD 34′ is connected to a gate of the amplifier transistor 36′. The source of the amplifier transistor 36′ is connected to the CDS/SH circuit 37′ through the row select transistor 43′. The electrical potential of the FD 34′ is output as an electrical potential signal from the source of the amplifier transistor 36′. The row select transistor 43′ controls the timing to output the electrical potential signal to the CDS/SH circuit 37′.

The CDS/SH circuit 37′ carries out a correlated double sampling for the pixel signal. By the correlated double sampling, the potential difference between the electrical potential signal of the reset FD 34′ and the electrical potential signal of the FD 34′ storing a signal charge is sampled and held as a pixel signal.

The output terminal of the CDS/SH circuit 37′ is connected to the output block 38′ through the column select transistor 40′ and a horizontal output line 44′. The column select transistor 40′ controls the timing to output the pixel signal held by the CDS/SH circuit 37′ to the output block 38′.

A transmit signal, which causes the transmit transistor 42′ to transmit the signal charge, a reset signal, which causes the reset transistor 35′ to reset the FD 34′, a row select signal, which causes the row select transistor 43′ to enable the electrical potential signal to be output, an SH signal, which causes the CDS/SH circuit 37′ to carry out the correlated double sampling, and a column select signal, which causes the column select transistor 40′ to output the pixel signal held by the CDS/SH circuit 37′, are output from the imaging device driver 21 at predetermined points in time.

The structure of the black pixel 31′b is same as that of the image pixel 31′i, except that the PD 41′ in the black pixel 31′b is shielded. In addition, the operations for generating a pixel signal are the same as those for generating the image pixel 31′i.

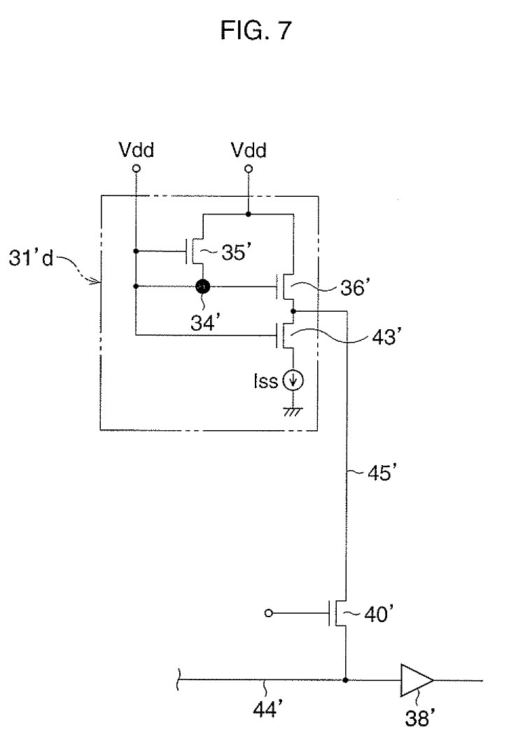

Next, the structure of the dummy pixel 31′d is explained below using the circuit diagram of FIG. 7. The dummy pixel 31′d comprises an FD 34′, a reset transistor 35′, an amplifier transistor 36′, a row select transistor 43′, and other compounds.

A source and a drain of the amplifier transistor 36′ are connected with a dummy output line 45′ and the Vdd respectively. The source of the amplifier transistor 36′ is grounded through the row select transistor 43′ and a current source, hereinafter referred to as Iss. A source and a drain of the reset transistor 35′ are connected with the FD 34′ and the Vdd respectively. The FD 34′ is connected with a gate of the amplifier transistor 36′. Gates of the reset transistor 35′ and the row select transistor 43′ are connected with the Vdd. Accordingly, the dummy pixel is different from the image pixel in regard to leaving a PD and a transmit transistor and connecting the gates of the reset transistor 35′ and the row select transistor 43′ with the Vdd.

The dummy output line 45′ is connected to the output block 38′ through a column select transistor 40′ and the horizontal output line 44′. The column select transistor 40′ controls the timing to transmit a dummy signal, which is the pixel signal output from the dummy pixel 31′d, to the output block 38′.

In the manufacturing process for the imaging block 39′, the image pixel 31′i, the black pixel 31′b, and the dummy pixel 31′d are all formed at the same time. Accordingly, the characteristics of the FD′ 34′, the reset transistor 35′, the amplifier transistor 36′, and the row select transistor 43′, which the dummy pixel 31′d comprises, are the same as those of the FD's 34′, the reset transistors 35′, the amplifier transistors 36′, and the row select transistors 43′, which the image pixel 31′i and the black pixel 31′b comprise.

The electrical potential of the dummy output line 45′, corresponding to the pixel signal generated by the dummy pixel 31′d, is decided by the electrical potential of the Vdd and the characteristics of the reset transistor 35′. The electrical potential of the dummy output line 45′ is almost equal to the electrical potential of the source of the amplifier transistor 36′ when the FD 34′ in the image pixel 31′i or the black pixel 31′b is reset. In addition, the electrical potential of the dummy output line 45′ is equal to the electrical potential obtained by subtracting the threshold voltage of the reset transistor 35′ from the electrical potential of the Vdd. Accordingly, the electrical potential of the dummy output line 45′ is equal to the electrical potential corresponding to a pixel signal when the exposure time is zero.

The CMOS imaging device 30′ can output a dummy signal equivalent to a pixel signal generated without a practical exposure time in addition to outputting the image-pixel signal and the black signal.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2005-179257 (filed on Jun. 20, 2005), which is expressly incorporated herein, by reference, in its entirety.

1. An image signal processor comprising:
a first setting block that sets an exposure time during which an optical image of an object is captured by an imaging device in order to generate an image signal;
an adjustment block that adjusts a black level of said image signal using a black signal, generated based on a signal output from a black pixel where the light receiving surface of said imaging device is shielded if said exposure time is over a threshold time; or a dummy signal, corresponding to said image signal when said exposure time is nearly zero if said exposure time is under said threshold time.

2. An image signal processor according to claim 1, further comprising a second setting block that sets an ISO sensitivity set for capturing said optical image by said imaging device; and said adjustment block changing said threshold time to be short in proportion to said ISO sensitivity being high.

3. An image signal processor according to claim 1, further comprising a second setting block that sets a gain used to amplify said image signal; and said adjustment block changing said threshold time to be short in proportion to said gain being large.

4. An image signal processor according to claim 1, wherein
said imaging device comprises a plurality of first photoelectric conversion element that generates a signal charge according to received light amounts, a second photoelectric conversion element that is shielded and has the same characteristic as said first photoelectric conversion element, and a first signal generator that generates a pixel signal based on said signal charge, and
said image signal is formed by a plurality of a image pixel signal generated by each of said first photoelectric conversion elements.

5. An image signal processor according to claim 4, wherein
said imaging device comprises a transmitter that has an electrical well and transmits said signal charge to said first signal generator by storing said signal charge in electrical well and moving said electrical well along said transmitter
said first signal generator generates said dummy signal based on a charge built up by moving said electrical well along said transmitter.

6. An imaging signal processor according to claim 4, wherein said imaging device comprises:
a first reset element that resets said signal charge received by said first signal generator and changes an electrical signal output to an input terminal of said first signal generator into a first standard signal according to a power source;
a second reset element that has the same characteristic as said first reset element, and outputs a second standard signal being virtually the same as said first standard signal; and
a second signal generator that has the same characteristic as said first signal generator, and that generates said dummy signal based on said second standard signal output from said second reset element.

7. An imaging unit comprising:
an imaging device comprising a plurality of first photoelectric conversion element that generates a signal charge according to received light amounts, a second photoelectric conversion element that is shielded and has the same characteristic as said first photoelectric conversion element, and a first signal generator that generates a pixel signal based on said signal charge and that generates a dummy signal, corresponding to said image signal when the exposure time, during which an optical image of an object captured, is nearly zero;
a first setting block that sets said exposure time;
an adjustment block that adjusts the black level of said image signal, which is a pixel signal generated based on said signal charge generated by said first photoelectric conversion element, using a black signal, generated based on said signal charge generated by said second photoelectric conversion element if said exposure time is over a threshold time; or using said dummy signal if said exposure time is under said threshold time.
